(19) United States
(12) Patent Application Publication
(10) Pub. No.: US 2009/0171868 A1
(43) Pub. Date: Jul. 2, 2009

(54) Method and Apparatus for Early Termination in Training of Support Vector Machines

(75) Inventors: Leon Bottou, Princeton, NJ (US); Ronan Collobert, Princeton, NJ (US); Jason Edward Weston, New York, NY (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 11/965,075

(22) Filed: Dec. 27, 2007

(51) Int. Cl. G06F 15/18

(52) U.S. Cl. 706/12

(57) ABSTRACT

Disclosed is a method for early termination in training support vector machines. A support vector machine is iteratively trained based on training examples using an objective function having primal and dual formulations. At each iteration, a termination threshold is calculated based on the current SVM solution. The termination threshold increases with the number of training examples. The termination threshold can be calculated based on the observed variance of the loss for the current SVM solution. The termination threshold is compared to a duality gap between primal and dual formulations at the current SVM solution. When the duality gap is less than the termination threshold, the training is terminated.

### BACKGROUND OF THE INVENTION

The present invention relates generally to machine learning, and more particularly to training support vector machines.

Machine learning involves techniques to allow computers to “learn”. More specifically, machine learning involves training a computer system to perform some task, rather than directly programming the system to perform the task. The system observes some data and automatically determines some structure of the data for use at a later time when processing unknown data.

Machine learning techniques generally create a function from training data. The training data consists of pairs of input objects (typically vectors), and desired outputs. The output of the function can be a continuous value (called regression), or can predict a class label of the input object (called classification). The task of the learning machine is to predict the value of the function for any valid input object after having seen only a small number of training examples (i.e. pairs of input and target output).

One particular type of learning machine is a support vector machine (SVM). SVMs are well known in the art, for example as described in V. Vapnik, Statistical Learning Theory, Wiley, New York, 1998; and C. Burges, A Tutorial on Support Vector Machines for Pattern Recognition, Data Mining and Knowledge Discovery 2, 121-167, 1998. Although well known, a brief description of SVMs will be given here in order to aid in the following description of the present invention.

Consider the classification shown in FIG. 1 which shows data labeled into two classes represented by circles and squares. The question becomes, what is the best way of dividing the two classes? An SVM creates a maximum-margin hyperplane defined by support vectors as shown in FIG. 2. The support vectors are shown as 202, 204 and 206 and they define those input vectors of the training data which are used as classification boundaries to define the hyperplane 208. The goal in defining a hyperplane in a classification problem is to maximize the margin (m) 210 which is the distance between the support vectors of each different class. In other words, the maximum-margin hyperplane splits the training examples such that the distance from the closest support vectors is maximized. The support vectors are determined by solving a quadratic programming (QP) optimization problem. There exist several well known QP algorithms for use with SVMs, for example as described in R. Fletcher, Practical Methods of Optimization, Wiley, New York, 2001; M. S. Bazaraa, H. D. Shrali and C. M. Shetty, Nonlinear Programming: Theory and Algorithms, Wiley Interscience, New York, 1993; and J. C. Platt, “Fast Training of Support Vector machines using Sequential Minimal Optimization”, Advances in Kernel Methods, MIT press, 1999.

As can be seen from FIG. 2, the optimal hyperplane 208 is linear, which assumes that the data to be classified is linearly separable. However, this is not always the case. For example, consider FIG. 3 in which the data is classified into two sets (X and 0). As shown on the left side of the figure, in one dimensional space the two classes are not linearly separable. However, by mapping the one dimensional data into 2 dimensional space as shown on the right side of the figure, the data becomes linearly separable by line 302. This same idea is shown in FIG. 4, which, on the left side of the figure, shows two dimensional data with the classification boundaries defined by support vectors (shown as disks with outlines around them). However, the class divider 402 is a curve, not a line, and the two dimensional data are not linearly separable. However, by mapping the two dimensional data into higher dimensional space as shown on the right side of FIG. 4, the data becomes linearly separable by hyperplane 404. The mapping function that calculates dot products between vectors in the space of higher dimensionality is called a kernel and is generally referred to herein as k. The use of the kernel function to map data from a lower to a higher dimensionality is well known in the art, for example as described in V. Vapnik, Statistical Learning Theory, Wiley, New York, 1998.

As described above, SVMs determine a maximum margin hyperplane based on a set of support vectors. The maximum margin hyperplane is determined by minimizing a primal cost function. However, directly solving the minimization problem may be difficult because the constraints can be quite complex. Accordingly, a dual maximization problem can be solved instead of the primal problem. The maximum of the dual problem is equal to the minimum of the primal problem, but the constraints of the dual problem are typically much simpler than those of the primal problem. In order to train SVMs an iterative optimization algorithm is used to maximize the dual problem. Typically, the optimization algorithm performs iterations until the dual problem converges at a maximum. However, it is desirable to expedite the SVM training process by early termination of the optimization algorithm before the optimum solution is reached, without loosing accuracy of the resulting SVMs.

### BRIEF SUMMARY OF THE INVENTION

The present invention provides a method and apparatus for early termination in training of a support vector machine (SVM). In accordance with the principles of the present invention, the training of an SVM can be terminated earlier as the amount of training data grows. Accordingly, embodiments of the present invention utilize a termination criterion that varies based on the number of training data examples used to train the SVM.

In one embodiment of the invention, a support vector machine is iteratively trained based on training data using an objective function having primal and dual formulations. At each iteration, an SVM solution is updated in order to increase a value of the dual formulation. A termination threshold is then calculated based on the updated SVM solution. The termination threshold can increase sublinearly with respect to the training data. The termination threshold can be calculated based on the observed variance of the loss for the updated SVM solution. A duality gap between the value of the dual formulation and the primal formulation based on the updated SVM solution is calculated. The termination threshold is compared to the duality gap, and when the duality gap is less than the termination threshold, the training is terminated.

These and other advantages of the invention will be apparent to those of ordinary skill in the art by reference to the following detailed description and the accompanying drawings.

### BRIEF DESCRIPTION OF THE DRAWINGS

FIG. 1 shows a 2-class data set;

FIG. 2 shows a 2-class data set classified using a maximum-margin hyperplane defined by support vectors;

FIG. 3 and 4 illustrate mapping lower dimensional data into higher dimensional space so that the data becomes linearly separable;

FIG. 5A illustrates a method for training an SVM based on a set of training examples according to an embodiment of the present invention;

FIG. 5B is pseudo code of the method shown in FIG. 5A; and

FIG. 6 shows a high level block diagram of a computer capable of implementing embodiments of the present invention.

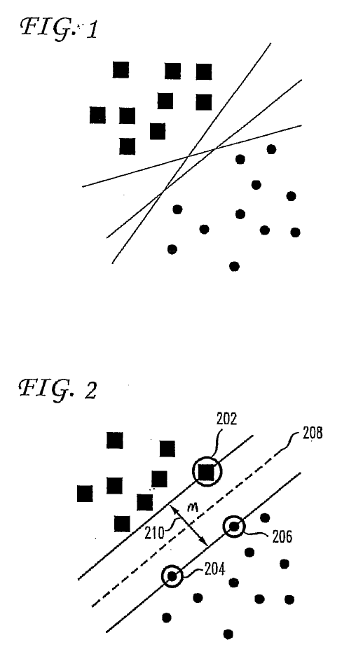

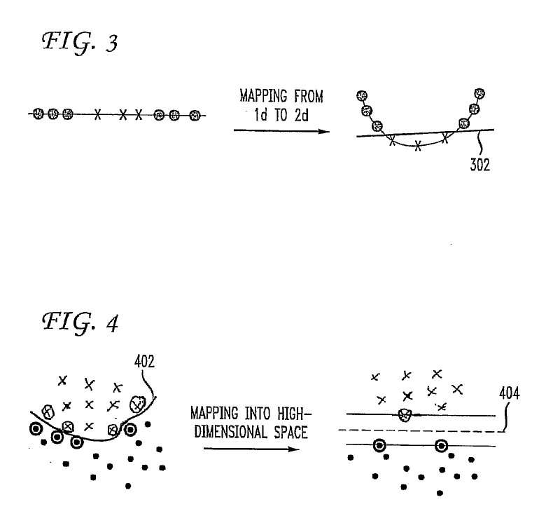

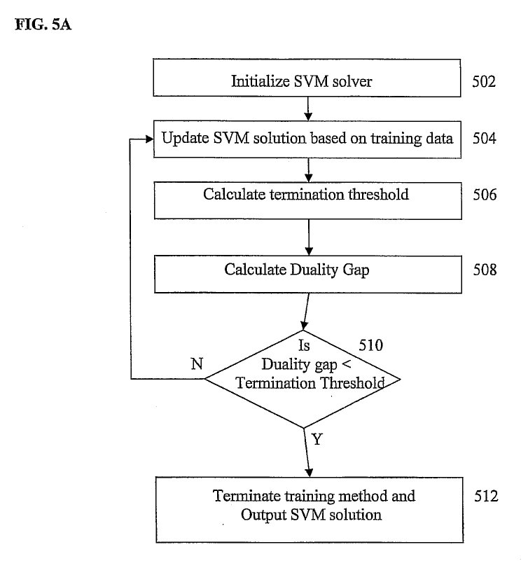

### DETAILED DESCRIPTION

The central role of optimization in the design of a machine learning algorithm derives naturally from a widely accepted mathematical setup of a learning problem. For example, a learning problem can be described as the minimization of the expected risk Q(f)=∫L(x,y,f)dP(x,y) in a situation where the ground truth probability distribution dP(x,y) is unknown, except for a finite sample {(x₁,y₁), . . . , (xₙ,yₙ)} of independently drawn examples. Statistical learning theory indicates this problem can be approached by minimizing the empirical risk Qₙ(f)=. . . n⁻¹ΣL(xᵢ,yᵢ,f) subject to a restriction of the form Ω(f)<Mₙ. This leads to the minimization of the penalized empirical risk:

$${Q}_{n , {λ}_{n}} ( f ) = {λ}_{n} Ω ( f ) + {n}^{- 1} {\sum }_{i = 1}^{n} L ( {x}_{i} , {y}_{i} , f ) \qquad ( 1 )$$

The penalized empirical risk expressed in Equation (1) can be minimized using various optimization algorithms. Embodiments of the present invention expedite this process by termination of such an optimization before reaching the optimum value. This “early termination” of an optimization algorithm is conceptually distinct from “early stopping” of an optimization algorithm. Early stopping interrupts the optimization algorithm when a cross-validation estimate reveals overfitting to the training data. Early termination terminates the optimization algorithm prior to convergence at the optimum value when it can be confidently asserted that the approximate solution will perform as well as the exact optimum.

The principles of the present invention can be applied to machine learning algorithms that admit a dual representation, and will be discussed mores specifically herein in the context of a support vector machine (SVM) algorithm solved in dual formulation. One skilled in the art will recognize that the principles of the present invention may be similarly applied to any other machine learning methods that admit a dual representation.

In an SVM training method, consider n training patterns x₁ . . . xₙ, and their associated labels y₁ . . . yₙ=±1. Let Φ be a feature map that represents a pattern x as a point Φ(x) in a suitable Hilbert space H. What is sought is a linear decision function f·Φ(x), parameterized by f εH, whose sign indicates the putative class of pattern x. In order to avoid minor technical complications in the discussion of the present invention, the decision function is described herein with no threshold. It is to be understood by those skilled in the art, that the principles of the present invention can also be applied using a threshold. If φ(v)=max(0,1−v) is the Hinge loss function, the minimization of the primal cost function can be expressed as:

$${min}_{f ∈ H} P ( f ) = \frac{1}{2} {‖ f ‖}^{2} + {C}_{n} {\sum }_{i} φ ( {y}_{i} f \cdot Φ ( {x}_{i} ) ) . \qquad ( 2 )$$

This primal cost function P(f) is an adaptation of the penalized empirical risk (Equation (1)) with L(x,y,f)=Φ(y f·Φ((x)), Ω=∥f∥²/2, and λₙ=1/nCₙ. This optimization problem admits a dual formulation:

$${max}_{α} D ( α ) = {\sum }_{i} {α}_{i} - \frac{1}{2} {\sum }_{i , j} {α}_{i} {α}_{j} {y}_{i} {y}_{j} K ( {x}_{i} , {x}_{j} ) \\ subject to 0 \leq {α}_{i} \leq {C}_{n} , ∀ i = 1 … n \qquad ( 3 )$$

where the function K(x,x′)=Φ(x)·Φ(x′) is called the kernel function. It is common to choose a kernel function, and to let Φ be implicitly defined by the choice of the kernel function. Let \hat{f} and \hat{α} be optimal solutions of problems (2) and (3), respectively. In this case, due to the strong duality property, for any feasible f and α,

$$D ( α ) \leq D ( \hat{α} ) = P ( \hat{f} ) \leq P ( f ) \\ and \\ \hat{f} = {\sum }_{i} {\hat{α}}_{i} {y}_{i} Φ ( {x}_{i} ) \qquad ( 4 )$$

Accordingly, the maximum of the dual formulation is equal to the minimum of the primal formulation, and the primal formulation (2) can be solved by optimizing the dual formulation (3).

Typical modern SVM solvers iteratively maximize the dual cost function (3) and terminate when a small predefined threshold ε exceeds the L_{ω} norm of the projection of the gradient (∂D(α)/∂αᵢ) on the constraint polytope. This quantity can be easily calculated during the iterative process. In conventional SVM solvers, the threshold ε is typically specified prior to training an SVM as a relatively small value, typically in the range 10⁻⁴ to 10⁻². Although some problems are capable of tolerating much larger thresholds, it is impossible to identify these problems prior to training, and using a large threshold is considered unreliable in convention SVM solvers.

In other SVM training methods, the threshold ε is compared to a duality gap between the primal and dual formulations. The duality gap is the difference between the primal formulation and dual formulation at a current values of f and α. As expressed in (4), at the optimal solution for the primal and dual formulations, the duality gap will be 0. In this case, optimization is terminated when the optimization method reaches α̅, f̅ such that:

$$ɛ > P ( \overline{f} ) - D ( \overline{α} ) \\ where \\ \overline{f} = {\sum }_{i} {\overline{α}}_{i} {y}_{i} Φ ( {x}_{i} ) \qquad ( 5 )$$

The strong duality property then guarantees that P( f̅)<P(\hat{f})+ε. Accordingly, termination is determined based on a difference between the primal formulation and the dual formation at each step of the iterative optimization algorithm. However, conventional SVM training methods using the duality gap use a predefined threshold ε, as described above.

Embodiments of the present invention utilize a threshold value ε that grows sublinearly with the number of training data examples n. Accordingly the threshold ε changes during the training process based on the training data. This is possible because:

$$\vert {Q}_{n , {λ}_{n}} ( f ) - {Q}_{n , {λ}_{n}} ( \hat{f} ) \vert = \frac{1}{{nC}_{n}} ( P ( \overline{f} ) - P ( \hat{f} ) ) \leq \frac{1}{{nC}_{n}} ( P ( \overline{f} ) - D ( \hat{α} ) ) \leq \frac{ɛ}{{nC}_{n}} {\to }^{n \to ∞} 0 \qquad ( 6 )$$

Letting ε grow makes the optimization coarser when the number of training examples increases. As a consequence, the asymptotic complexity of early-terminated optimization can be smaller than that of the exact optimization.

In order for the termination threshold ε to grow with the number of training examples, it is necessary to calculate a termination threshold based on the training data that guarantees nearly the same generalized performance as the exact optimization algorithm for finite training sets. Accordingly values of the termination threshold ε must be determined to ensure that Q( f̅)≈Q(\hat{f}). Suppose that an SVM learning algorithm always returns a constant \hat{f}₀ independently of the training examples Sₙ={(x₁,y₁) . . . (xₙ,yₙ)}. The distribution of Q(\hat{f}₀)−Qₙ(\hat{f}₀) can then be described by the central limit theorem regardless of the actual distribution function dP(x,y). In particular, for any η>0, c(η)>0 can be found such that:

$$P \{ \vert Q ( {\hat{f}}_{0} ) - {Q}_{n} ( {\hat{f}}_{0} ) \vert > c ( η ) \sqrt{\frac{{Var}_{x , y} L ( x , y , {\hat{f}}_{0} )}{n}} \} > 1 - η . \qquad ( 7 )$$

Accordingly, it can be assumed that, for any reasonable learning algorithm \hat{f}(Sₙ), the deviations Q(\hat{f}(Sₙ))−Qₙ(\hat{f}(Sₙ)) are larger than those prescribed by the central limit theorem:

$${P}_{{S}_{n}} \{ \vert Q ( \hat{f} ( {S}_{n} ) ) - {Q}_{n} ( \hat{f} ( {S}_{n} ) ) \vert > c ( η ) \sqrt{\frac{{Var}_{x , y} L ( x , y , \hat{f} ( {S}_{n} ) )}{n}} \} > 1 - η . \qquad ( 8 )$$

Let \hat{f}=inf_{feH}P(f) be the solution of the primal problem (2) and f̅=Σyᵢ α̅ᵢxᵢ be an approximate solution satisfying P( f̅)−D( α̅)≦ε. In this case, the quantities Q( f̅)−Qₙ(\hat{f}) and Q(\hat{f})−Qₙ(\hat{f}) can be compared using the following relation:

$$\frac{Q ( \overline{f} ) - {Q}_{n} ( \hat{f} )}{Q ( \hat{f} ) - {Q}_{n} ( \hat{f} )} = \frac{Q ( \overline{f} ) - {Q}_{n} ( \overline{f} )}{Q ( \hat{f} ) - {Q}_{n} ( \hat{f} )} + \frac{{Q}_{n} ( \overline{f} ) - {Q}_{n} ( \hat{f} )}{Q ( \hat{f} ) - {Q}_{n} ( \hat{f} )} \qquad ( 9 )$$

The first ratio on the right hand side of (9) is close to the unity because both divergences Q( f̅)−Qₙ( f̅) and Q(\hat{f})−Qₙ(\hat{f}) involve relatively close f̅ and \hat{f}. Since the empirical averages are computed on the same training set, the losses φ(yₖ f̅·Φ(xₖ)) and φ(yₖ\hat{f}·Φ(xₖ)) are strongly correlated. Under sufficient assumptions on the probability distributions, this leads to better convergence rates for the difference (Q( f̅)−Q(\hat{f}))−(Qₙ( f̅)−Qₙ(\hat{f})) than for the deviation Q(\hat{f})−Qₙ(\hat{f}). Therefore, making Qₙ( f̅)−Qₙ(\hat{f}) significantly smaller than Q(\hat{f})−Qₙ(\hat{f}) ensures that Q( f̅)−Qₙ(\hat{f}) is close to Q(\hat{f})−Qₙ(\hat{f}). On one hand:

$${Q}_{n} ( \overline{f} ) - {Q}_{n} ( \hat{f} ) \approx \frac{1}{{nC}_{n}} ( P ( \overline{f} ) - P ( \hat{f} ) ) \leq ( P ( \overline{f} ) - D ( \overline{α} ) ) \leq \frac{ɛ}{{nC}_{n}} \qquad ( 10 )$$

On the other hand, using (8),

$$c ( η ) \sqrt{\frac{{Var}_{x , y} L ( x , y , f )}{n}} \leq \vert Q ( \overline{f} ) - {Q}_{n} ( \overline{f} ) \vert \approx \vert Q ( \hat{f} ) - {Q}_{n} ( \hat{f} ) \vert \qquad ( 11 )$$

Therefore, a termination threshold ε can be used that is proportional to the empirical approximation of the variance of the loss function measured based on the training data, such that:

ε˜Cₙ\sqrt{nVar_{x,h}L(x,y,f)}≈Cₙ{square root over (nVarₖφ(yₖf·Φ(xₖ)))}. (12)

Accordingly, the duality gap can be compared to the termination threshold ε determined based on the observed variance of the loss function of the training data at each step in an SVM training method in order to determine whether to terminate the training method.

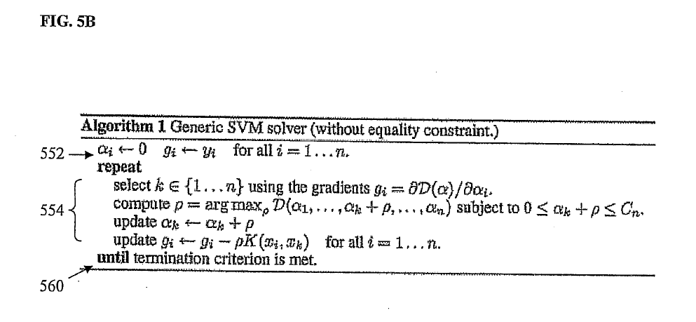

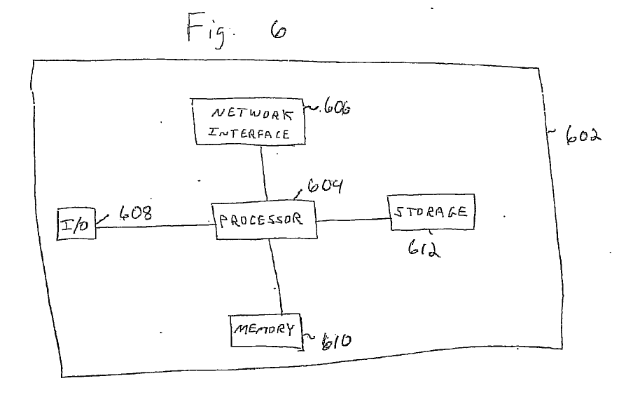

FIG. 5A illustrates a method for training an SVM based on a set of training examples according to an embodiment of the present invention. The method of FIG. 5A utilizes a termination threshold that grows sublinearly with the number of training examples during the training of the SVM to determine whether to terminate the training method. FIG. 5B is pseudo code for implementing the method of FIG. 5A using a simplified Sequential Minimal Optimization (SMO) SVM training method. Standard SMO is a well-known training method that changes two a coefficients by opposite amounts in order to maintain an equality constraint. The method of FIGS. 5A and 5B is a simplified method similar to SMO that has no equality constraint, and thus, considers only one a coefficient at each iteration. It is to be understood that the principles of the present invention are not limited to the method of FIGS. 5A and 5B and can be similarly applied to the SMO training method or any other training method.

At step 502, an SVM solver is initialized resulting in an initial SVM solution. The SVM solver is initialized by initializing the variables of the dual formulation to an initial value for all of the training data examples. This results in an initial solution for the SVM that will be updated with iterations of the SVM training method. This step is shown at 552 in the pseudo code of FIG. 5B. As shown at 552 in FIG. B the variable α is set to 0 for all of the training examples.

At step 504, the SVM solution is updated based on training data. The SVM solution is updated by calculating an update step for a variable of the dual formulation in order to maximize the dual formulation as much as possible within certain constraints. This step is shown at 554 in the pseudo code of FIG. 5B. As shown in FIG. B, in the SMO training method, a coordinate corresponding to a training example is selected to be updated based on gradients of the dual formulation, and a step is calculated for updating the coordinate in order to maximize the dual formulation subject to constraints. The variable α for the coordinate is updated by the step, and the gradients of the dual formulation are recalculated based on the update. This results in the updated SVM solution.

At step 506, the termination threshold ε is determined based on the current SVM solution. As described above the termination threshold ε can be determined based on observed variance of the loss function of the training examples for the current SVM solution, as expressed in (12). Accordingly, the variance of the loss function can be approximated and the approximation of the variance of the loss function can be used to determine the termination threshold ε. The variance of the loss can be calculated by calculating the losses for all training data examples, and calculating the empirical variance between the losses.

At step 508, the duality gap is calculated for the current SVM solution. As described above the duality gap is the difference between the primal formulation for the current SVM solution and the dual formulation for the current SVM solution. Accordingly, the current value for the dual formulation D(α) is calculated based on the current α, and the current α is used to calculate the current f in order to calculate the current value for the primal function P(f). The duality gap P(f)−D(α) can then be calculated.

At step 510, it is determine whether the current duality gap P(f)−D(α) is less than the current termination threshold ε. If the current duality gap P(f)−D(α) is less than the current termination threshold ε, the termination criterion is met, and the method proceed to step 512. If the current duality gap P(f)−D(α) is not less than the current termination threshold ε, the termination criteria is not met and the method returns to step 504 and performs another iterative update to the SVM solution. Steps 506-510 of FIG. 5A are shown at 560 in the pseudo code of FIG. 5B. Accordingly, these steps can be used to determine whether termination criteria has been met in the SMO training method.

At step 512, when the termination criteria has been met, the SVM training method is terminated and the current SVM solution is output. For example, the SVM solution can be stored in memory or storage of a computer system in order to generate an SVM which can be used to classify data similar to the training data.

The method of FIG. 5A expedites the SVM training process as compared to conventional methods, since the termination threshold can grow based on the number of training examples. This can lead to reduced training time without sacrificing accuracy of the trained SVMs. SVMs trained using this method can be used in various applications. For example, one such application for a trained SVM using an embodiment of the present invention is cancer screening in medical images. In this case, training examples of medical image containing and not containing cancers can be used to train an SVM to classify input medical images as cancerous or not cancerous. Another possible application for an SVM trained using the above described method is spam detection in email. In this case the SVM can be trained based on training examples of spam and non-spam emails. Another possible application for an SVM trained using the above described method is face recognition in images. In this case, the SVM can be trained based on training examples of portions of images containing a face and portions of images not-containing a face. It is to be understood that these examples of SVM applications do not limit the present invention in any way, and SVMs trained according to an embodiment of the present invention can be used to classify any type of data or for any other purpose for which SVMs are used.

The steps of the method of FIG. 5A may be performed by computers containing processors which are executing computer program code which defines the functionality described herein. Such computers are well known in the art, and may be implemented, for example, using well known computer processors, memory units, storage devices, computer software, and other components. A high level block diagram of such a computer is shown in FIG. 6. Computer 602 contains a processor 604 which controls the overall operation of computer 602 by executing computer program instructions which define such operation. The computer program instructions may be stored in a storage device 612 (e.g., magnetic disk) and loaded into memory 610 when execution of the computer program instructions is desired. Thus, the operation of computer 602 is defined by computer program instructions stored in memory 610 and/or storage 612 and the computer 602 will be controlled by processor 604 executing the computer program instructions. Accordingly, computer program instructions for performing the steps of the method of FIG. 5A can be stored in memory 610 and/or storage 612 and executed by processor 604 executing the computer program instructions. Computer 602 also includes one or more network interfaces 606 for communicating with other devices via a network. Computer 602 also includes input/output 608 which represents devices which allow for user interaction with the computer 602 (e.g., display, keyboard, mouse, speakers, buttons, etc.). One skilled in the art will recognize that an implementation of an actual computer will contain other components as well, and that FIG. 6 is a high level representation of some of the components of such a computer for illustrative purposes. One skilled in the art will also recognize that the functionality described herein may be implemented using hardware, software, and various combinations of hardware and software.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for training a support vector machine based on training data using an objective function, the objective function having a primal formulation and a dual formulation, comprising:
(a) initializing an SVM solver using the dual formulation to determine an initial SVM solution;
(b) updating the SVM solution to increase a value of the dual formulation;
(c) calculating a termination threshold based on the SVM solution resulting from step (b), wherein said termination threshold increases with a number of training data examples;
(d) calculating a duality gap between the value of the dual formulation and a value of the primal formulation for the SVM solution resulting from step (b); and
(e) repeating steps (b)-(d) until the duality gap is less than the termination threshold.

2. The method of claim 1, wherein said termination threshold increases sublinearly with the number of training data examples.

3. The method of claim 1, wherein step (c) comprises:
calculating the termination threshold based on an approximation of a variance of a loss function for the training data examples based on the SVM solution resulting from step (b).

4. The method of claim 1, wherein step (b) comprises:
updating the SVM solution using a Sequential Minimal Optimization (SMO) step to maximize a value of the dual formulation within a set of constraints.

5. The method of claim 1, wherein step (b) comprises: selecting at least one coordinate, corresponding to at least one training data example, in the dual formulation based on a gradient at the at least one coordinate;
calculating an update step for said at least one coordinate to maximize the dual formulation within a set of constraints;
updating said at least one coordinate based on the update step; and
recalculating the gradient of the at least one coordinate.

6. An apparatus for training a support vector machine based on training data using an objective function, the objective function having a primal formulation and a dual formulation, comprising:
means for initializing an SVM solver using the dual formulation to determine an initial SVM solution;
means for iteratively updating the SVM solution to increase a value of the dual formulation;
means for calculating a termination threshold based on the SVM solution resulting from each iterative update, wherein said termination threshold increases with a number of training data examples;
means for calculating a duality gap between the value of the dual formulation and a value of the primal formulation for the SVM solution resulting from each iterative update; and
means for terminating training of the SVM when the duality gap is less than the termination threshold.

7. The apparatus of claim 6, wherein said termination threshold increases sublinearly with the number of training data examples.

8. The apparatus of claim 7, wherein said means for calculating a termination threshold comprises:
means for calculating the termination threshold based on an approximation of a variance of a loss function for the training data examples based on the SVM resulting from each iterative update.

9. The apparatus of claim 6, wherein said means for iteratively updating the SVM solution comprises:
means for iteratively updating the SVM solution using Sequential Minimal Optimization (SMO).

10. The apparatus of claim 6, wherein said means for iteratively updating the SVM solution comprises:
means for selecting at least one coordinate, corresponding to at least one training example, in the dual formulation based on a gradient at the at least one coordinate;
means for calculating an update step for said at least one coordinate to maximize the dual formulation within a set of constraints;
means for updating said at least one coordinate based on the update step; and
means for recalculating the gradient of the at least one coordinate

11. A computer readable medium storing computer executable instructions for training a support vector machine based on training data using an objective function, the objective function having a primal formulation and a dual formulation, said computer executable instructions defining steps comprising:
(a) initializing an SVM solver using the dual formulation to determine an initial SVM solution;
(b) updating the SVM solution to increase a value of the dual formulation;
(c) calculating a termination threshold based on the SVM solution resulting from step (b), wherein said termination threshold increases with a number of training data examples;
(d) calculating a duality gap between the value of the dual formulation and a value of the primal formulation for the SVM solution resulting from step (b); and
(e) repeating steps (b)-(d) until the duality gap is less than the termination threshold.

12. The computer readable medium of claim 11, wherein said termination threshold increases sublinearly with the number of training data examples.

13. The computer readable medium of claim 11, wherein the computer executable instructions defining step (c) comprise computer executable instructions defining the step of:
calculating the termination threshold based on an approximation of a variance of a loss function for the training data based on the SVM solution resulting from step (b).

14. The computer readable medium of claim 11, wherein the computer executable instructions defining step (b) comprise computer executable instructions defining the step of:
updating the SVM solution using a Sequential Minimal Optimization (SMO) step to maximize a value of the dual formulation within a set of constraints.

15. The computer readable medium of claim 11, wherein the computer executable instructions defining step (b) comprise computer executable instructions defining the steps of:
selecting at least one coordinate, corresponding to at least one data training example, in the dual formulation based on a gradient at the at least one coordinate;
calculating an update step for said at least one coordinate to maximize the dual formulation within a set of constraints;
updating said at least one coordinate based on the update step; and
recalculating the gradient of the at least one coordinate.
